(19) United States
(12) Patent Application Publication
(10) Pub. No.: US 2009/0157985 A1
(43) Pub. Date: Jun. 18, 2009

(54) Accessing memory arrays

(75) Inventors: Ashley Miles Stevens, Cambridge (GB); Daren Croxford, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 12/000,889

(22) Filed: Dec. 18, 2007

(51) Int. Cl. G06F 12/00; G06F 15/18

(52) U.S. Cl. 711/154; 706/21; 711/E12.001

(57) ABSTRACT

A memory controller for controlling access to a memory, said memory comprising at least one memory array, said at least one memory array comprising a plurality of rows and a plurality of columns, access to an element within said memory array being performed by opening a row comprising said element and then accessing a column comprising said element, said at least one memory array being adapted to have no more than one row in said at least one memory array open at a time; said memory controller being responsive to a memory access request to access an element within said memory and following said access to determine if said row comprising said accessed element should be closed or should remain open in dependence upon a property of said memory access request.

### BACKGROUND OF THE INVENTION

1. Field of the Invention

The field of the invention relates to data processing and in particular to storing data in memories and in preferred embodiments SDRAM memories.

2. Description of the Prior Art

Memory arrays such as SDRAM memories are known, in which elements are accessed in dependence upon a row address and a column address. To access a row the row needs to be opened or activated using sense amplifiers, the column is then selected and the appropriate element accessed. In such memory arrays only one row can be open at any one time. Furthermore, the closing of a row (by precharging) and the opening of another row both take time. Thus, in situations where consecutive memory accesses access elements in a same row it would be advantageous not to close the row between accesses. In other situations where different rows are to be accessed closing the rows between accesses improves performance.

Traditionally these memories have had a global policy on whether or not a row should be closed following a memory access, and this policy is usually decided at reset.

FIG. 1 shows a SDRAM 10 according to the prior art, the SDRAM 10 having a plurality of banks 12, each comprising an array of storage elements in columns and rows and each operable to have single row open at any one time. The rows in a particular bank are activated by latching all the cells along a word (row) line of the bank to corresponding sense amplifiers 13. A column is selected and then a data element can be addressed, such that the data element stored in the activated row and column can be read out from the sense amplifiers 13 to the Input/output buffers 14 or a new data element can be written to the activated address. To “close” a row the sense amplifiers are pre-charged. This step must be performed before a different row can be activated.

“History-Based Memory Mode Prediction for Improving Memory Performance” by Seong-II Park et al, 0-7803-7761-3/03 IEEE pages V-185 to V-188 discloses a system with a predictive mode control scheme, where the local access history of each memory bank is used to predict the memory mode, of either leaving a row open following access or closing it.

The paper considers how a predictor could be used for each row of the memory but remarks that the use of 2 bits of prediction history per row would have unacceptable overheads with regard to area, thus it uses 2 bits per bank and has a predictive scheme for each bank. However, such a coarse grained scheme would not provide much improvement in performance with regard to conventional systems.

“An Effective SDRAM Power Mode Management Scheme for Performance and Energy Sensitive Embedded Systems” by Ning-Yuan Ker et al. discloses a system where the policy of leaving a row open or closed between accesses is decided on the basis of how busy the bus interface/interconnect is. Thus, in a high power operating mode the rows are left open, whereas in a lower power mode they are closed. A drawback of this is that in some cases where consecutive memory accesses are predominantly to different rows then leaving the rows open between accesses will actually decrease performance.

“Power Aware page Allocation” by Lebeck et al. Nov. 12-15, 2000 discloses a memory access technique where they try to optimize power by generally leaving the accessed page open, however, if the page is not accessed for a certain length of time then they close it as they assume it will not be accessed again.

It would be desirable to be able to improve performance of memory accesses to a memory array such as an SDRAM and to reduce the power consumption of such a memory where the rows are left open following an access while not dropping performance to the level of the always closed case.

### SUMMARY OF THE INVENTION

A first aspect of the present invention provides a memory controller for controlling access to a memory, said memory comprising at least one memory array, said at least one memory array comprising a plurality of rows and a plurality of columns, access to an element within said memory array being performed by opening a row comprising said element and then accessing a column comprising said element, said at least one memory array being adapted to have no more than one row in said at least one memory array open at a time; said memory controller being responsive to a memory access request to access an element within said memory and following said access to determine if said row comprising said accessed element should be closed or should remain open in dependence upon a property of said memory access request.

The present invention recognises that the pattern of memory access requests often depends on a property of the memory access request itself and as such, this property can be used to determine whether or not a row of an accessed element should be open or should be closed. As mentioned earlier the performance of memory array accesses where only one row can be opened at any one time depends on whether the row following an access is left open or closed. If a different row is to be accessed then closing the previous one will provide increased performance whereas if the same row is to be accessed then leaving it open will increase performance. Furthermore, closing a row results in a lower power state than leaving it open would, so closing a row can have power advantages. However, opening a closed row requires a lot of power so closing a row that is to be accessed next is not power efficient. Thus, some predictive method in which the probability of that row being accessed again can be assessed would be helpful in improving the performance of such memory accesses. The present invention recognises this and also recognises that the properties of the memory access request itself may provide an indication as to whether or not the subsequent access will be to the same row and thus, it can be used to determine whether or not to keep the row open and thereby improve performance.

In some embodiments, said property comprises a predicted probability that is a function of said memory access request transaction, said memory controller comprising prediction logic for calculating said predicted probability, said predicted probability predicting whether a subsequent memory access to said memory array would be to a same row.

The property of the memory access request may be a function of the memory access request transaction and prediction logic can be used to calculate the predicted probability of a subsequent access being to the same row in dependence upon a property of that memory access request transaction.

In some embodiments, said memory access request comprises a signal generated by a source of said memory access request, said signal comprising an indication as to whether a subsequent memory access would be to a same row, said prediction logic calculating said predicted probability from said signal.

Some memory access requests may have a signal generated by a source of the request transmitted with the request as perhaps a sideband signal. Such a signal may provide an indication as to whether a subsequent memory access will be to a same row and the prediction logic can therefore calculate the predicted probability using this information. For example, previous and current memory access requests may be used to provide an indication of a probability of a subsequent access being to the same row, and this probability could be sent as the sideband signal. A source of the memory access request may for example comprise hardware that can analyse transaction patterns in previous requests to predict the probability of subsequent accesses being to the same row and this information could be provided to the memory controller.

In some embodiments, said memory access request is received from a central processing unit and said signal indicates whether said memory access request is for instructions or data, said memory controller being responsive to said signal indicating a data access request to close said row following said data access and being responsive to said signal indicating an instruction access request to leave said row open following said instruction access.

Some central processing units such as an ARM® processor provide a signal associated with an instruction or a data access request that indicates whether that request is for data or for an instruction. Data accesses are often to random addresses in the memory whereas instruction accesses are often to subsequent addresses. Thus, the prediction logic can use the information present in this signal to determine whether to close a row after an access in the case of a data access or to leave it open as in the case of an instruction access.

In some embodiments, said prediction logic calculates said predicted probability in dependence upon a source of said memory access request, said memory controller being responsive to memory access requests from predetermined sources to leave said row open following said memory access and being responsive to memory access requests from other sources to close said row following said memory access.

The source of a memory access request also has a bearing on whether or not it is likely that the accesses are to consecutive addresses or to random addresses. Thus, this information can be used by the memory controller to predict the probability of a subsequent access being to a same row. For example, sources of memory access requests such as video controllers, LCD controllers or DMA controllers usually access consecutive addresses and as such, memory access requests from these generate a predictive probability that predicts that a subsequent memory access would be to a same row and thus, the memory controller leaves the row open for such memory access requests.

In some embodiments, said source is indicated by an identifier associated with said memory access request, said prediction logic calculating said predicted probability in dependence upon said identifier.

Although, the memory controller can identify the source in a number of ways, in some embodiments it is identified by an identifier associated with the memory access request. Often signals sent via interconnects have an identifier associated with them which identifies the source of that request. This can be used by the memory controller and the prediction logic to calculate the predicted probability.

In some embodiments, said prediction logic is adapted to determine a plurality of predicted probabilities for at least one of said memory access requests and to determine a resultant probability for said at least one of said memory access requests, said resultant probability being dependant on a function of said plurality of predicted probabilities.

As can be appreciated there may be more than one function of a memory access request that might affect whether or not the memory access request is likely to be to consecutive addresses or to random addresses. The prediction logic of some embodiments of the invention may determine a predicted probability of a subsequent access being to a same row based on one of these functions. In other embodiments, it may calculate a plurality of predicted probabilities based on a plurality of these functions, for example, the source of the request and a sideband signal connected with the request. In the latter case, these predicted probabilities are combined in a particular way to determine a resultant probability, the resultant probability being used as the property of the memory access request that the memory controller uses to determine whether or not to leave the row open. The combination may comprise giving different priorities to the different features and combining them in a weighted way, alternatively it may decide to consider only the one with the highest priority when determining the resultant probability.

Although the memory can be a number of different things in some embodiments it is a SDRAM memory. These are memories that are commonly used with system on chips and have the property that only one row can be opened at any one time in the memory array and that opening and closing rows takes time and power.

In some embodiments, said memory comprises a plurality of memory arrays arranged as a plurality of banks each of said banks comprising a plurality of rows and a plurality of columns and each bank being adapted to have no more than one row in said bank open at a time, said memory controller being adapted to determine whether rows should remain open or be closed following memory accesses in each of said banks.

Memories such as SDRAM's have a number of banks. Each bank can be separately accessed and each can have a row open at any one time. Alternatively, the memory can be a memory system comprising a plurality of memory chips each comprising a plurality of memory arrays arranged as banks.

In some embodiments, said property comprises a stored property of said memory access request; said memory controller having access to a data store for storing said property for at least a part of a recently accessed row within said memory array, said stored property comprising a predicted probability predicting whether a subsequent memory access to said memory array would be to a same row.

Although the property might be a property assessed by prediction logic based on the memory access request transaction in some embodiments it is a stored property that is stored in a data store. At least some of the elements that are recently accessed have this predicted probability stored associated with them and this can be used to assess whether or not a row should be left open. Although it is the row that is left open so that the probability can be determined for and associated with a complete row. In some embodiments the probability is associated with each individual data element within a row and the probability then determined for a particular element or part of a row accessed. It should be noted that by only storing the predicted probabilities associated with recently accessed addresses or rows, portions of the memory that are active are covered and not those that are inactive, this avoids storing too much information. If information is stored for each memory element then the power advantage gained by not having to close and open rows so often would be lost by the disadvantage due to the increase in area and power required for such a large data store.

In some embodiments, said memory controller comprises prediction logic, wherein in response to a memory access request said memory controller accesses said data store; and in response to detecting an entry for said element said memory access controller determines if said row comprising said accessed element should be closed or should remain open in dependence upon said stored predicted probability; and in response to detecting no entry in said data store for said element, said memory controller determines a predicted probability that is a function of said memory access request transaction using said prediction logic, and determines if said row comprising said accessed element should be closed or should remain open in dependence upon said determined predicted probability.

Stored predicted probabilities can be used in conjunction with prediction logic for calculating prediction probabilities from the memory access request itself thus, as the data store only stores at least some of the recently accessed memory access requests if there is no information for a particular memory access request then a prediction probability can be determined using the prediction logic, while if there is one stored then this prediction probability can be used. In this way, the advantage of a static prediction system whose predictions are based on memory access transaction requests can be used alongside a dynamic one that can update stored prediction probabilities and improve prediction successes in this way. In some embodiments, as is discussed later, the two probabilities can be combined to generate a resultant final predicted probability that is a function of both the stored probability and the probability predicted using the predication logic.

In some embodiments said memory controller further comprises allocation logic, wherein in response to detecting no entry in said data store corresponding to said memory access, said allocation logic determines from said memory access request whether or not said data store should be allocated said predicted probability determined using said prediction logic for said address accessed, and in response to said allocation logic determining it should be said memory controller allocates said predicted probability to said data store.

In some embodiments, there is allocation logic provided which determines whether or not an entry should be stored in the data store for a particular address. It may be that some addresses are easy to predict using prediction logic and as such it is not necessary to use the dynamic prediction as no or only a small improvement would be gained. In such cases it is worth determining this so that the storage spaces in the data store are saved for addresses where prediction is more difficult and where dynamic schemes can therefore be helpful.

In some embodiments, said allocation logic is adapted to determine whether said data store should be allocated a value or not in dependence upon a source of said memory access request.

For example, the source of the memory access request may determine whether the probability of a subsequent memory access being to the same row can be predicted fairly successfully. In some cases, the source may be a video controller or an LCD controller where memory access requests are nearly always to subsequent addresses. In such cases, storing prediction probabilities in a data store and updating them does not improve the prediction rates and as such it is better not to waste storage space by storing this information.

Although the data store storing predictive probabilities can be located in a number of places in some embodiments it is within the memory controller itself.

In some embodiments, said prediction logic is adapted to determine a plurality of predicted probabilities for at least some of said memory access requests and to determine a resultant probability for each of said at least some of said memory access requests, said resultant probability being dependant on a function of said plurality of predicted probabilities and said stored predicted probability.

As mentioned previously there are a number of functions of a memory access request that can be used to predict probabilities of a subsequent memory access being to a same row. There is also the predicted probabilities that can be stored in a data store and updated in a dynamic way. In some embodiments the memory controller can be responsive to all or some of these probabilities by calculating a resultant probability from a function of these different probabilities, including the stored probability.

A further aspect of the present invention provides a data processing apparatus comprising a memory controller according to a first aspect of the present invention, wherein said property comprises a predicted probability that is a function of said memory access request transaction, said memory controller comprising prediction logic for calculating said predicted probability, said predicted probability predicting whether a subsequent memory access to said memory array would be to a same row; and wherein said memory access request comprises a signal generated by a source of said memory access request, said signal comprising an indication as to whether a subsequent memory access would be to a same row, said prediction logic calculating said predicted probability from said signal; said data processing apparatus further comprising a plurality of masters, said plurality of masters being in data communication with said memory controller via an interconnect, said plurality of masters being adapted to generate said signal to add to said memory requests, said signal comprising an indication as to whether an accessed row should be left open or closed.

A further embodiment of the present invention provides a data processing apparatus comprising a memory controller according to a first aspect of the present invention; wherein said property comprises the stored property of said memory access request; said memory controller having access to a data store for storing said property for at least some elements recently accessed within said memory array said stored property comprising a predicted probability predicting whether a subsequent memory access to said memory array would be to a same row, a master and a memory management unit, said memory management unit comprising said data store.

Although the data store can be in a number of places, in an alternative embodiment it is within the memory management unit (MMU). The memory management unit already comprises information on addresses within the memory and thus, adding a few extra bits to this data store enables the predicted probabilities of the particular addresses to be stored in an efficient manner. A drawback of this is that the memory management unit itself would have to be altered to include this feature. It should be noted that the MMU may be the CPU MMU or it may be a system MMU or IOMMU (input/output MMU) that manages the address translations for masters other than the CPU as well as perhaps address translations for a hyper-visor in a virtualized system.

A still further aspect of the present invention provides a memory controller for controlling access to a memory comprising at least one memory array, said at least one memory array comprising a plurality of rows and a plurality of columns, access to an element within said at least one memory array being performed by opening a row comprising said element and then accessing a column comprising said element, said memory array being adapted to have no more than one row in said at least one memory array open at a time; said memory controller having access to a data store for storing a predicted probability for at least some elements recently accessed within said memory array, said predicted probability predicting whether subsequent memory accesses to said memory array are to a same row, said memory controller being responsive to a memory access request to an element to access said data store and in response to said predicted probability to either leave said row open or to close said row following said memory access.

Storing information regarding predicted probabilities for each data element within a memory array would increase the likelihood of correctly predicting whether to leave a row open following a data access but would impact heavily on storage area and power. However, selecting to store this information for at least some recently accessed data provides a good compromise of not storing too much data but storing data for addresses that you are likely to use. Recently accessed elements within a memory are more likely to be accessed again than elements that have not been accessed for some time as generally portions of a memory are active at any one time. Thus, providing a data store for storing predicted probabilities for recently accessed elements provides a good way of predicting whether or not to leave rows open.

In some embodiments, said memory controller is adapted to increase said stored predicted probability in response to an access that is subsequent to an access to said element being in a same row, and to decrease said stored predicted probability in response to said subsequent access being in a different row.

The stored probabilities can be dynamically changed while the memory is accessed and this can improve prediction rates. If a subsequent access to a memory element is within a same row then it is likely that the next time this element is accessed the subsequent access will also be to the same row. Thus, increasing the probability in this way provides a dynamic way of predicting whether or not to close a row that can improve the performance of the memory.

Although the predicted probability can be stored in a number of ways in some embodiments it is stored in a saturating counter.

Incrementing and decrementing a value in response to certain events is simply done using a saturating counter. If for many accesses in a row the row remains open then the counter simply saturates to its highest probability value. When memory accesses switch to random areas within the memory then there will be subsequent accesses in different rows and the counter will be decremented until it goes beneath a threshold value whereupon the predicted probability will be predicting that the row should be closed following the access. The counter can be a variety of sizes for example it could store a single bit indicating either that it is probable or it is improbable or it could be a two bit counter which could indicate highly probable and a weaker probability.

A yet still further of the present invention provides a method of controlling accesses to a memory, said memory comprising at least one memory array, said at least one memory array comprising a plurality of rows and a plurality of columns, access to an element within said memory array being performed by opening a row comprising said element and then accessing a column comprising said element, said at least one memory array being adapted to have no more than one row in said at least one memory array open at a time; said method comprising the steps of: receiving a memory access request to an element; determining if said row comprising said accessed element should be closed or should remain open in dependence upon a property of said memory access request; accessing said element; and either leaving said row open or closing it in dependence upon said determination.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 shows a conventional SDRAM memory;

FIG. 2 shows a system on chip and associated memory chip according to an embodiment of the present invention;

FIG. 3 shows a memory controller according to an embodiment of the present invention;

FIG. 4 illustrates the storage of predicted probabilities for a memory controller according to an embodiment of the present invention;

FIG. 5 shows predication and allocation logic for a memory controller according to an embodiment of the present invention;

FIG. 6 shows a system on chip and associated memory system according to a further embodiment of the present invention; and

FIG. 7 shows a flow diagram illustrating a method according to an embodiment of the present invention.

### DESCRIPTION OF THE PREFERRED EMBODIMENTS

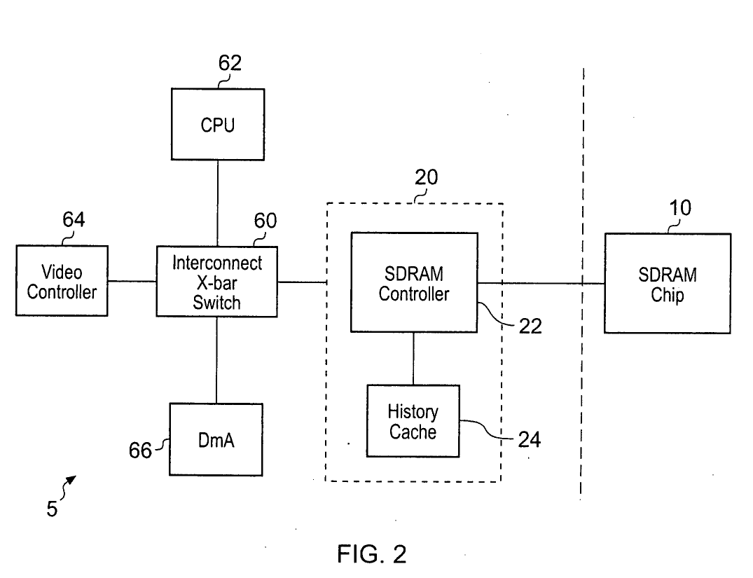

FIG. 2 shows a system on chip 5 having a plurality of masters including a central processing unit 62, a video controller 64 and a DMA 66. These are interconnected via interconnect 60 and they communicate with an external memory portion 22 and a data store 24 for storing a history of data accesses.

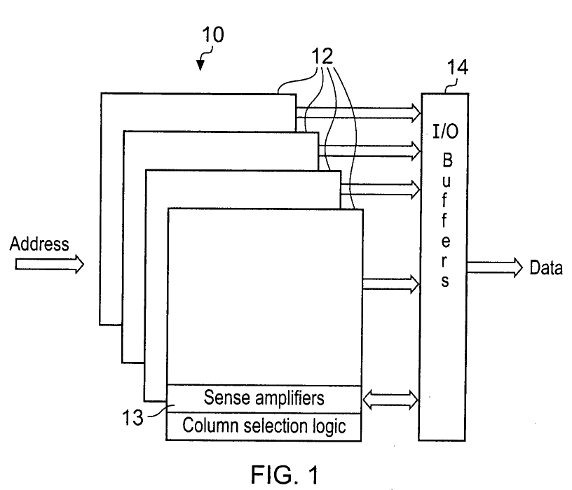

External memory 10 is a SDRAM chip such as the one shown in FIG. 1. In order to increase performance of such a memory it is advantageous to leave a row open if a subsequent memory access is to be to the same row and to close the row if it is not to the same row. In this embodiment memory controller 20 has a history data store 24 associated with it. This data store stores a history of previous recent memory accesses and an indication of the probability of subsequent accesses to these accesses being in a same row. This therefore provides a dynamic prediction method whereby data of recent memory access patterns is stored and used to predict future one. Memory accesses are generally such that if a memory access is in the same row as a previous memory access it is likely that a subsequent memory access will be to the same row. Thus, storing this history information in a data store is a way of predicting future access patterns based on past ones.

In this embodiment memory accesses to the SDRAM chip 10 are processed by SDRAM controller 22 and for each access the history cache 24 is accessed to see if there is a stored predicted probability for that address. If there is then the controller leaves the row open or closes it in dependence upon this stored predicted probability. Following the memory access the controller analyses it to see whether access was indeed to the same row or to a different row. The stored predicted probability is then updated with this information. Thus, if it was to the same row the probability of it being to the same row is increased if it was to a different row then it is decreased. It may be that this stored probability is stored as a single value thus, it is either probable or it is improbable. Thus, in response to an access being to the same row the probability goes to probable and in response to it being in a different row the probability goes to improbable.

The history cache 24 only stores information for recent memory accesses. Thus, it may be that for a particular memory access there is no information in history data store 24. In such a case, the controller 20 decides whether to leave the row open or closed based on other criteria. It may be that it decides globally to leave it open or globally to leave it closed. It may use other prediction mechanisms which are described with respect to later embodiments. In any case, following the data access this address is entered into the data store 24 along with the information as to whether or not the subsequent access was to a same or different row. In this way, the data store 24 contains information for recent memory accesses and as portions of memory are generally active for some time it is likely that memory access requests received will be to addresses that have corresponding entries in the data store 24 for a significant amount of time. In this way an appropriate subset of memory access information can be stored that is likely to be useful.

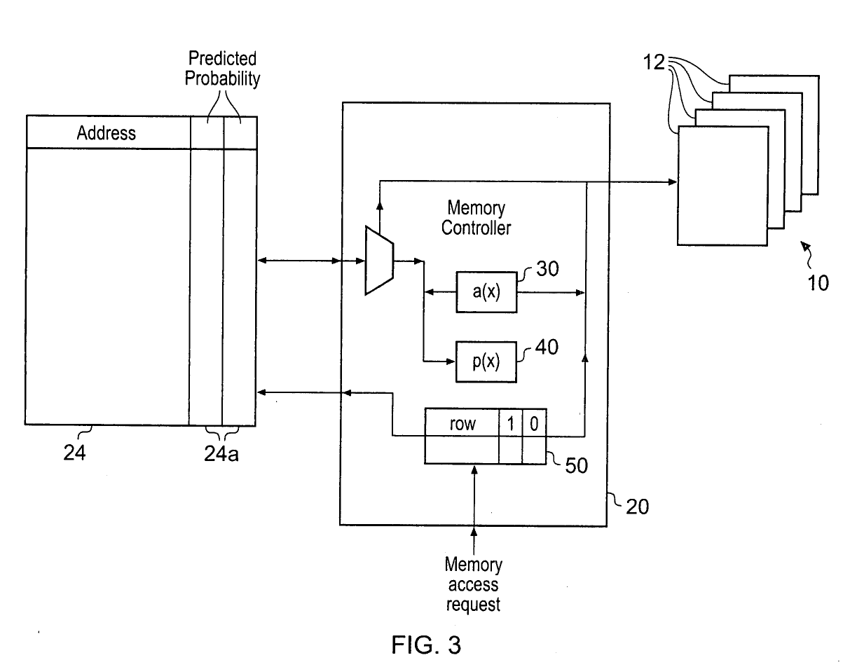

FIG. 3 shows a memory controller 20 and data store 24 according to a further embodiment of the present invention. In this embodiment memory controller 20 comprises a state store 50 for storing information regarding a previous row accessed by a preceding memory access request and it also comprises prediction logic 40, and allocation logic 30. On receipt of a memory access request by memory access controller 20, it acts to compare the row of the access request with the row that was previously accessed in that bank, this information being stored in state store 50. If it is present in the state store 50 then it is clear that the memory access request is to a same row as the previous request. This information is input to data store 24 and the probability associated with the previous address is incremented by 1. If there is a miss when the state store 50 is accessed, in other words the row is different to the previous row accessed then the probability associated with the previous address is decremented by 1. In addition to the identification of the previous row accessed state store 50 also stores information as to whether that row is actually open. This is because the memory chip 10 must be refreshed from time to time at which point all rows are pre-charged or closed. Thus, although the row itself might be closed it was still the row that was accessed in a previous preceding memory access request and as such the probability of a subsequent request to that address should be incremented.

Data store 24 is then checked to see whether or not information relating to the address requested by the memory access request is stored in the data store 24. If it is, the probability 24a associated with that address is sent to memory controller 20 and the memory access is made in memory 10 and the row is left open or is closed depending on the value of the probability 24a stored in data store 24.

If there is no entry for the address in data store 24 then prediction logic 40 is accessed and a prediction is made as to the probability of a subsequent access being to the same row based on the properties of the memory access request itself. This probability is then used when the memory is accessed to determine whether or not the row should be left open. In addition to this, allocation logic 30 analyses the properties of the memory access request and determines whether or not the information relating to this memory access request should be stored in data store 24. It may be that the property of the memory access request is such that the probability as to whether or not the row should be left open or closed can be predicted very accurately. If this is the case then there is little advantage to be gained in storing the address and probability in the data store as there will be little or no increase in prediction success by using the dynamic method of updating probabilities with respect to history of data accesses. Thus, in such a case the data store 24 is not updated with this information. If, however the allocation logic 30 does not determine that the memory access request falls into this category then the data store is sent the address of this memory access request and the determined probability from the prediction logic 40 and this data overwrites an entry in data store 24. In this way data store 24 stores the recent addresses accessed in the memory.

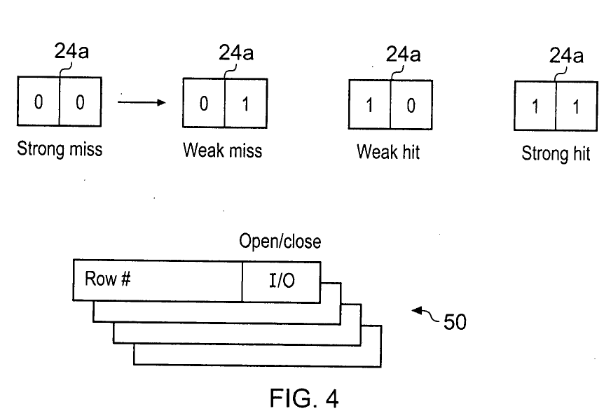

FIG. 4 shows an example of the probability bits 24a stored in data store 24 and also shows the state store 50 relating to the various banks of memory 10 in more detail. In response to getting a hit in data store 50 the probability associated with the corresponding entry in data store 24 is incremented. In this current embodiment there is a saturated counter 24a that stores the probability of a row remaining open or being closed. In the case of a 00 this means that there has not been a recent hit and it is therefore very improbable that there will be a hit and it should be closed 01 is weakly improbable, 10 is a weakly probable hit and therefore the row should be left open and 11 is very probable and the row should be left open. Thus, in response to a 00 or 01 the row will be closed and in response to a 10 or 11 the row will be left open. Each time a subsequent access is to a same row in other words there is a hit in data store 50, then the counter is incremented. Thus, if it is strongly improbable that the row should remain open in other words a strong miss, then a hit will give a weak miss so that it is still improbable that the row should remain open and the subsequent access will see the row closed again after the access. However, a subsequent access to the same row will see the counter incremented to a weak hit and thus, an access to that row again will mean that the row is left open.

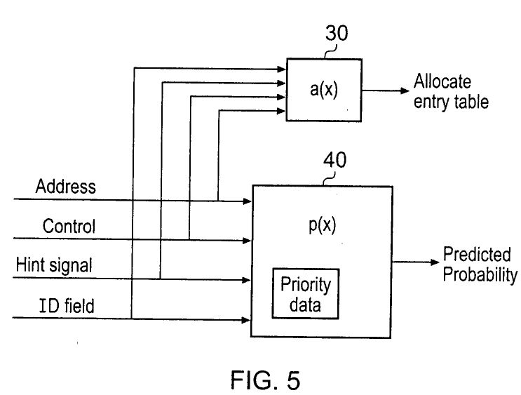

FIG. 5 shows prediction logic 40 and allocation logic 30 in more detail. Prediction logic 40 receives memory access requests which comprise several features including the address to be accessed, a control signal indicating the type of access, possibly a hint signal or a sideband signal and an identifier field. The identifier field indicates what master the request comes from and the hint signal provides an indication as to whether or not the row should be closed. This hint signal may for example be a signal from a processor indicating that the memory access is a data access or an instruction access. Data accesses are generally to random locations and as such it is probable that the row should be closed after such an access while instruction accesses are generally to consecutive addresses and thus generally the row should be left open. The identifier field relates to the source of the memory access request. Some sources are strongly incrementing memory access patterns like LCD controllers and DMA controllers and thus, such an identifier detected by prediction logic results in it predicting that the row should be left open. Prediction logic 40 analyses the features of the memory access request and determines a predicted probability from these features.

As shown in this figure, there may be a number of different signals received by the prediction logic and these can be used to provide a prediction as to whether or not the row should be left open. In such cases, the prediction logic will prioritize these using priority information stored within it and will determine a predicted probability on this basis.

Allocation logic 30 acts to control the allocation of entries in table 24. Prediction logic 40 is generally used where there is not prediction information stored already in table 24 and thus, the advantages of dynamic prediction using a relatively small memory along with the use of prediction logic where no dynamic predictions are stored in the small memory provides for an efficient prediction system. Thus, where there is not an entry in the table allocation logic 30 can act to allocate an entry in the table to this access request so that the table stores the most recent access request. However, it can also determine in some circumstances that this memory access should not be allocated an entry in the table. It may do this in cases where the properties of the access request are such that the predicted probability is already quite certain and thus, it will not be significantly improved by allocating an entry in the table. This may be for example where the ID field indicates an LCD or video controller. These have strongly incrementing patterns of memory accesses and as such, it is nearly always advantageous to leave the row open. Thus, the prediction logic can successfully predict in most cases for these sources and it is not worth allocating an entry to data store 24.

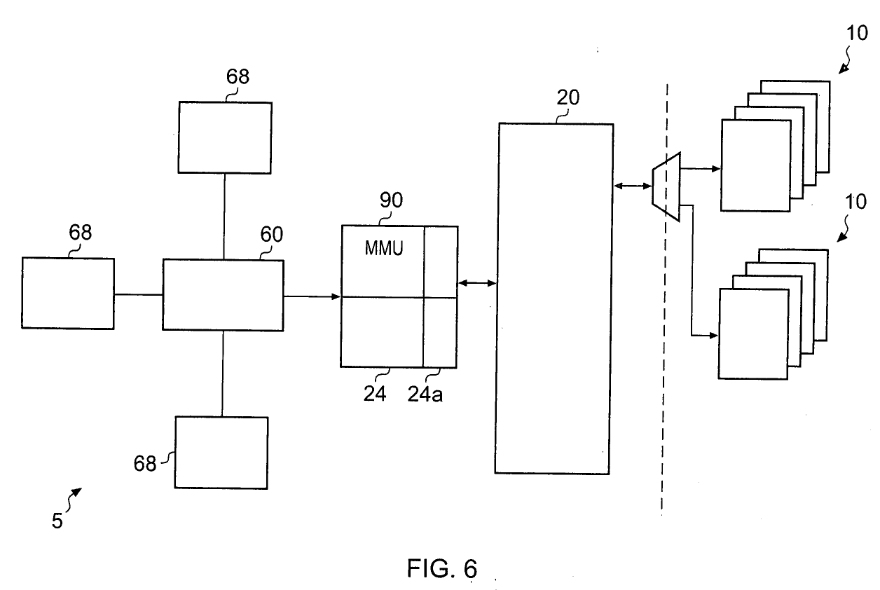

FIG. 6 shows a system on chip 5 according to a further embodiment of the present invention. In this embodiment there are a plurality of masters 68 connected to an interconnect 60 which in turn is connected via a management memory unit 90 to memory controller 20. Memory management unit 90 which may be the CPU MMU, a system MMU or an input/output MMU comprises page tables that indicate the memory mapping for the memories 10 of the of the memory system. The memory management unit 90 has a Transaction Lookaside Buffer (TLB) that caches the page tables. A TLB entry may contain probability prediction information 24a which predicts whether or not the row should be left open after a memory access to these addresses and is based either on predicted values from prediction logic or on historical values. Storing the data in this way means that the address information associated with each probability prediction does not need to be separately stored as it is already stored in the memory management unit and thus, the number of bits required to store this information is small.

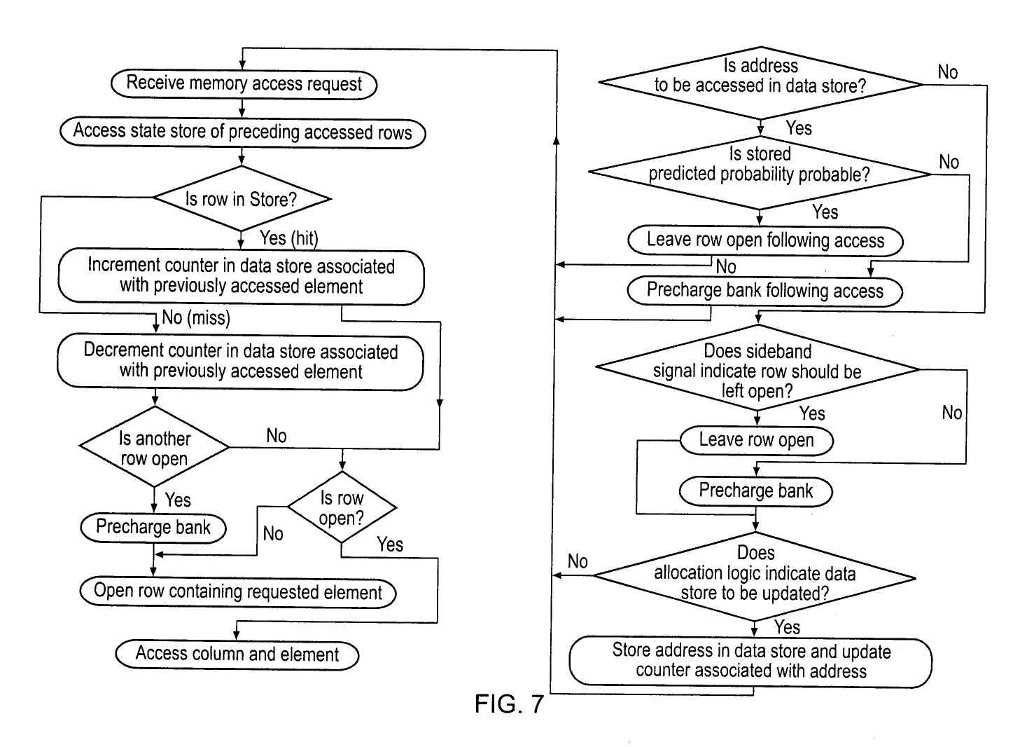

FIG. 7 shows a flow diagram illustrating a method according to an embodiment of this invention. In this method a memory access request is received. The state store indicating the preceding accessed rows is then accessed and if there is a hit then it is determined the row is open. At the same time the counter in the data store associated with the previously accessed element is incremented. If the row is open then the column is accessed and the element is accessed. If the row is not open then it determines if another row is open. If it is it pre-charges the bank. If it isn't then it simply opens the row containing the requested element. The element is then accessed.

If it is determined that the row is not in the store then it then proceed to determine if another row is open but at the same time it decrements the counter in the data store associated with the previously accessed element. In parallel to this accessing of the memory element and updating the data store there is a separate determination made of whether the address to be accessed is stored in the data store. If it is then it is determined if it is probable that the row will be accessed by the next data access and if yes then the row is left open following the access and the next memory access request is received. If it is determined that it is improbable that the next access is the same row then the bank is pre-charged following the memory access and the next memory access is received.

If it is determined that the address to be accessed is not in the data store then the sideband signal for example is analysed by the prediction logic to see if the row should be left open. If it should be left open then the row is left open and allocation logic is accessed. If the allocation logic indicates that the data store should not be updated with this information then the next memory access is received. If the allocation logic indicates the data store should be updated then the address is stored in the data store and the probability data is set to indicate that the row should be left open. If the sideband signal indicates that the row should not be left open then the bank is pre-charged and allocation logic is accessed to see if the data store needs to be updated. If it does need to be updated then a low probability is entered along with the address of that memory access, the next memory access is then received.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A memory controller for controlling access to a memory, said memory comprising at least one memory array, said at least one memory array comprising a plurality of rows and a plurality of columns, access to an element within said memory array being performed by opening a row comprising said element and then accessing a column comprising said element, said at least one memory array being adapted to have no more than one row in said at least one memory array open at a time;
said memory controller being responsive to a memory access request to access an element within said memory and following said access to determine if said row comprising said accessed element should be closed or should remain open in dependence upon a property of said memory access request.

2. A memory controller according to claim 1, wherein said property comprises a predicted probability that is a function of said memory access request transaction, said memory controller comprising prediction logic for calculating said predicted probability, said predicted probability predicting whether a subsequent memory access to said memory array would be to a same row.

3. A memory controller according to claim 2, wherein said memory access request comprises a signal generated by a source of said memory access request, said signal comprising an indication as to whether a subsequent memory access would be to a same row, said prediction logic calculating said predicted probability from said signal.

4. A memory controller according to claim 3,
wherein said memory access request is received from a central processing unit and said signal indicates whether said memory access request is for instructions or data, said memory controller being responsive to said signal indicating a data access request to close said row following said data access and being responsive to said signal indicating an instruction access request to leave said row open following said instruction access.

5. A memory controller according to claim 2,
wherein said prediction logic calculates said predicted probability in dependence upon a source of said memory access request, said memory controller being responsive to memory access requests from predetermined sources to leave said row open following said memory access and being responsive to memory access requests from other sources to close said row following said memory access.

6. A memory controller according to claim 5,
wherein said predetermined sources comprise at least one of a video controller, and LCD controller and a DMA controller.

7. A memory controller according to claim 5,
wherein said source is indicated by an identifier associated with said memory access request, said prediction logic calculating said predicted probability in dependence upon said identifier.

8. A memory controller according to claim 2, said prediction logic being adapted to determine a plurality of predicted probabilities for at least some of said memory access requests and to determine a resultant probability for each of said at least some of said memory access requests, said resultant probability being dependant on a function of said plurality of predicted probabilities.

9. A memory controller according to claim 1, wherein said memory is an SDRAM memory.

10. A memory controller according to claim 1, wherein said memory comprises a plurality of memory arrays arranged as a plurality of banks each of said banks comprising a plurality of rows and a plurality of columns and each bank being adapted to have no more than one row in said bank open at a time, said memory controller being adapted to determine whether rows should remain open or be closed following memory accesses in each of said banks.

11. A memory controller according to claim 10, wherein said memory comprises a memory system comprising a plurality of memory chips each comprising a plurality of memory arrays arranged as banks.

12. A memory controller according to claim 1;
wherein said property comprises a stored property of said memory access request;
said memory controller having access to a data store for storing said property for at least some elements recently accessed within said memory array, said stored property comprising a predicted probability predicting whether a subsequent memory access to said memory array would be to a same row.

13. A memory controller according to claim 12, said memory controller comprising prediction logic, wherein in response to a memory access request said memory controller accesses said data store; and
in response to detecting an entry for said element said memory access controller determines if said row comprising said accessed element should be closed or should remain open in dependence upon said stored predicted probability; and
in response to detecting no entry in said data store for said element, said memory controller determines a predicted probability that is a function of said memory access request transaction using said prediction logic, and determines if said row comprising said accessed element should be closed or should remain open in dependence upon said determined predicted probability.

14. A memory controller according to claim 13, said memory controller further comprising allocation logic, wherein in response to detecting no entry in said data store corresponding to said memory access, said allocation logic determines from said memory access request whether or not said data store should be allocated said predicted probability determined using said prediction logic for said address accessed, and in response to said allocation logic determining it should be said memory controller allocates said predicted probability to said data store.

15. A memory controller according to claim 14, wherein said allocation logic is adapted to determine whether said data store should be allocated a value or not in dependence upon a source of said memory access request.

16. A memory controller according to claim 12, wherein said memory controller is adapted to increase said stored predicted probability in response to an access that is subsequent to an access to said element being in a same row, and to decrease said stored predicted probability in response to said subsequent access being in a different row.

17. A memory controller according to claim 16, wherein said stored predicted probability is stored in a saturating counter.

18. A memory controller according to claim 12, said memory controller comprising said data store.

19. A memory controller according to claim 13, said prediction logic being adapted to determine a plurality of predicted probabilities for at least one of said memory access requests and to determine a resultant probability for said at least one of said memory access requests, said resultant probability being dependant on a function of said plurality of predicted probabilities and said stored predicted probability.

20. A data processing apparatus, comprising a memory controller according to claim 3, and a plurality of masters, said plurality of masters being in data communication with said memory controller via an interconnect, said plurality of masters being adapted to generate said signal to add to said memory requests, said signal comprising an indication as to whether an accessed row should be left open or closed.

21. A data processing apparatus, comprising a memory controller according to claim 3, and a plurality of masters, said plurality of masters being in data communication with said memory controller via an interconnect, said interconnect being adapted to generate said signal to add to said memory requests, said signal comprising an indication as to whether an accessed row should be left open or closed.

22. A data processing apparatus, comprising a memory controller according to claim 12, a master and a memory management unit, said memory management unit comprising said data store.

23. A memory controller for controlling access to a memory comprising at least one memory array, said at least one memory array comprising a plurality of rows and a plurality of columns, access to an element within said at least one memory array being performed by opening a row comprising said element and then accessing a column comprising said element, said memory array being adapted to have no more than one row in said at least one memory array open at a time;
said memory controller having access to a data store for storing a predicted probability for at least some elements recently accessed within said memory array, said predicted probability predicting whether subsequent memory accesses to said memory array are to a same row, said memory controller being responsive to a memory access request to an element to access said data store and in response to said predicted probability to either leave said row open or to close said row following said memory access.

24. A memory controller according to claim 23, wherein said memory controller is adapted to increase said stored predicted probability in response to an access that is subsequent to an access to said element being in a same row, and to decrease said stored predicted probability in response to said subsequent access being in a different row.

25. A memory controller according to claim 24, wherein said stored predicted probability is stored in a saturating counter.

26. A method of controlling accesses to a memory, said memory comprising at least one memory array, said at least one memory array comprising a plurality of rows and a plurality of columns, access to an element within said memory array being performed by opening a row comprising said element and then accessing a column comprising said element, said at least one memory array being adapted to have no more than one row in said at least one memory array open at a time;
said method comprising the steps of:
receiving a memory access request to an element;
determining if said row comprising said accessed element should be closed or should remain open in dependence upon a property of said memory access request;
accessing said element; and
either leaving said row open or closing it in dependence upon said determination.
